(19) United States
(12) Patent Application Publication
(10) Pub. No.: US 2003/0203689 A1
(43) Pub. Date: Oct. 30, 2003

(54) Method for adhering fabric to rubber and composites

(76) Inventors: Joseph S. Burke, Moon Township, PA (US); Deborah Ann Smith, Glenmoore, PA (US)

Correspondence Address: COZEN AND O'CONNOR, 1900 MARKET STREET, PHILADELPHIA, PA, 19103, US

(21) Appl. No.: 10/134,011

(22) Filed: Apr. 25, 2002

(51) Int. Cl. B32B 25/00

(52) U.S. Cl. 442/149; 442/152; 442/159; 442/168; 442/169; 442/170

(57) ABSTRACT

A method of adhering rubber to fabric comprising applying a composition comprising an α, β ethylenically unsaturated monomer, and/or oligomer to a surface of the fabric, joining the rubber and adhesive surface of the fabric, and heating and pressing to vulcanize the rubber and bond the fabric to the rubber. The resultant composites are disclosed.

### BACKGROUND OF THE INVENTION

1. Field of the Invention

This invention relates to adhesive compositions and methods, particularly to adhesives for bonding rubber to fabric and reinforcing rubber compounds with fabric.

2. State of the Art

The success of reinforced molded rubber goods depends on good adhesion of the reinforcement to the rubber. Fabrics made with synthetic yarns are difficult to bond. In practice as the fibers are drawn a spin finish is applied which may contain an adhesion activator such as an epoxy resin. The yarn may be heat set before or after weaving. Heat setting is required to relax the orientation put into the fiber by drawing. With polyester there is about 12% shrinkage if not constrained. If constrained, the relaxation is internal to the fiber. To get good bonding to rubber, an adhesive dip coat is applied to the fabric. This process may involve many steps and is tailored to each application, i.e., a different adhesive may be used depending on the fabric type and the rubber it is to be molded with.

Some of the steps may include a pretreatment dip of a polyisocyanate dissolved in a solvent. The fabric is then dried and put through a forced air oven to cure the coating and heat set the fabric. This operation is followed by a subsequent dip treatment in a resin-reinforced latex (RFL) bath, and a second trip through the oven. The composition of these baths may include the addition of other adhesive promoters such as epoxies, phenolics, or the like. RFL is made by preparing a 6% resin solution of resorcinol and formaldehyde or other methylene donor in water. This solution is allowed to react for a certain time at a specified pH and temperature and is then poured into a rubber latex, and the blend is again allowed a certain time to “mature” before using. The shelf life of the dip adhesive is variable depending on the pH and the ingredients. It can be from 1 day to 1 month. We have found out that converters who make these blends try to control the process as much as possible, but the making of RFL is tricky and it doesn't always come out the same. Shoaf, U.S. Pat. No. 3,307,966, assigned to E.I. DuPont describes such a process.

Health, environmental and energy concerns must be addressed and handled in a manner to satisfy regulatory limits when evaporating solvents and heat curing the adhesives at a temperature near 200° C. in a gas fired forced air oven.

Adhesion of the rubber to the treated fabric is often not adequate in the prior art. In many cases an added adhesion promoter is required in the rubber compound to improve the adhesion to the level that cohesive failure of the rubber is evidenced in a peel test.

### SUMMARY OF THE INVENTION

These objects and others which will become apparent from the following disclosure are achieved by the invention which in one aspect comprises a method of adhering rubber to fabric comprising applying an adhesive composition comprising an α, β-ethylenically unsaturated monomer, and/or oligomer to a surface of the fabric, heating and/or irradiating the fabric, joining the rubber and adhesive surface of the fabric, and heating and pressing to vulcanize the rubber and bond the fabric to the rubber.

In another aspect the invention comprises composites of the fabric adhered to the rubber.

It is preferred to partially or fully cure the adhesive after it has been applied to the fabric by heat and/or radiation. If heat is to be used, a thermal free radical initiator such as a peroxide compound should be included in the composition, whereas if UV radiation is to be used, a photoinitiator should be included in the composition. If electron beam radiation is used, a photoinitiator is not required. Typical amounts of initiator are about 0.1 to 5 parts based on weight of monomer and/or oligomer.

In the case of thermal initiation of free radical polymerization of the composition, the fabric can be heated for about 30 to 300 seconds at 75 to 250 deg. C., for example, and preferably in the presence of air.

In the case of radiation initiation of free radical polymerization, conventional UV or electronic beam equipment can be used.

The monomer and/or oligomer composition is preferably 100% active and is preferably a multifunctional monomer and/or oligomer with a solubility parameter near that of the polymer making up the fabric. Suitable solubility parameters are about 8 to 17 Hildebrand units, and the monomer and/or oligomers preferably have a solubility parameter selected to be within one Hildebrand unit of the fabric. Several of such monomers and/or oligomers have been demonstrated to give good adhesion between fabric and rubber. The preferred monomer and/or oligomers are selected from the group consisting of acids, esters, metallic salts, and amides. Di-, tri-, or tetra-acrylates or methacrylates, especially ditrimethylolpropane triacrylate, ethoxylated pentaerythritol tetraacrylate, and tris (2-hydroxy ethyl) isocyanurate triacrylate, are preferred monomers. Among the oligomers are any of the well known low molecular polymers known in the art as oligomers, for example epoxy (meth)acrylates, urethane (meth)acrylates, polyester (meth)acrylates, low viscosity aliphatic epoxy (meth)acrylates based on Bisphenol A, and the like. By “(meth)acrylate” we mean acrylates, methacrylates, and mixtures thereof. Liquid low molecular weigh polybutadiene oligomer resins with maleic anhydride and epoxy functionality may also be suitable since they are expected to cure on fabric.

Natural or synthetic rubber can be used in the invention. Suitable rubbers include any of the well known rubbers, for example EPDM.

Any synthetic or natural fabric may be used, with the preferred ones being cotton, rayon, nylon, polyester, and aramid.

The resulting composite has very good bond strength between the rubber and fabric, and is itself part of the invention.

The advantages are a system that has a very rapid cure with essentially no off gases. The compounds can be used almost instantaneously after being made, and the shelf life is months in the absence of UV light. The simplicity is evident, and the results are as good as can be achieved with alternate systems. We believe that the results are more consistent than realized with prior adhesive systems.

### DETAILED DESCRIPTION OF A PREFERRED EMBODIMENT

When the treated fabric was molded with EPDM according to the invention, which contained no adhesion promoter, there was about 20 lbs./inch peel strength with little or no cohesive failure of the rubber. When molded with an adhesion promoter in the rubber there was greater peel strength of about 40 lbs./inch and 100% cohesive failure of the rubber. These results are at least as good as can be obtained with the current RFL technology.

### EXAMPLES

Adhesive compositions were prepared and applied to polyester fabric, and UV cured. The fabric was PET, 9 oz./sq.yd., conveyor belt fabric from Dan River with an epoxy finish. Pieces around 12″×12″ were heat set for 90 seconds at 185-195 C. A piece of uncoated heat set fabric, around 2½″×9″ weighed. The weight was recorded as “w1”. A sample of the formulation was poured on a glass plate. A roller was rolled in this sample to put a thin film on the roller, which was then rolled on the fabric to transfer the film to it. The fabric was taped to a carrier plate, and put through the UV oven, which had a “D” bulb @300 watts/inch running at 50 ft/min. The fabric was turned over, coated, and cured on this side with the same procedure as above. The fabric, now coated on both sides, was weighed as “w2”. The % pick up was calculated as (w2-w1)/w1×100.

Very good results were obtained by carrying out the method and using the composition of the invention.

With no coagent in the rubber, 20 lbs/inch and zero % cohesive failure is about state of the art. With 10 phr SR 633 adhesion promoter in the rubber we have previously achieved up to 32 lbs/inch and 100% cohesive failure. Surprisingly, to get good adhesion to polyester fabric, multifunctional monomers and photoinitiators are all that is needed in a UV cured system.

The following Tables illustrate the invention.

| Formulation | A | B | C | D | E | F |
|---|---|---|---|---|---|---|
| Ingredients | | | | | | |
| Ditrimethylolpropane | 95 | | | | | |
| Triacrylate | | | | | | |
| Ethoxylated Pentaerytbritol | | 95 | | | | |
| Tetraacrylate | | | | | | |
| Tris (2-Hydroxy Ethyl) | | | 95 | | | |
| Isocyanurate Triacrylate | | | | | | |
| Low Viscosity Monoacrylate | | | | 75 | | |
| Trifunctional Acid Ester | | | | 20 | | |
| Polyester Acrylate | | | | | 19 | |
| Polyester Acrylate | | | | | | 19 |
| Distilled Water | | | | | 80 | 80 |
| KTO 46 | 5 | 5 | 5 | 5 | 1 | 1 |
| Percent Active | 95 | 95 | 95 | 95 | 19 | 19 |
| Viscosity, Cps | | | | | 14 | 32.5 |

DATA:

| Formulation | A | | B | | C | |
|---|---|---|---|---|---|---|
| Fabric # | A1 | A2 | B1 | B2 | C1 | C2 |
| Uncoated wt(w1) | 7.87 | 8.05 | 8.1 | 7.66 | 8.54 | 7.77 |
| Coated wt(w2) | 8.52 | 8.87 | 8.57 | 8.15 | 9.12 | 8.08 |
| % Pick Up | 8.3 | 10.2 | 5.8 | 6.4 | 6.8 | 4.0 |
| Formulation | D | | E* | | F* | |
| Fabric # | D1 | D2 | | E | | F |
| Uncoated wt(w1) | 7.73 | 8.35 | | 15.37 | | 14.95 |
| Coated wt(w2) | 8.33 | 9.05 | | 16.49 | | 16.11 |
| % Pick Up | 7.8 | 8.4 | | 7.3 | | 7.8 |

*The water based formulations ″E″ and ″F″ were made at 19% solids.
Fabric pieces ca. 5″ wide by 9″ long were coated with a draw down rod on one side. The glass plate was wiped off, and a paper towel was placed on it. The fabric was turned over, and placed on the paper towel.
The draw down rod was pulled over it to squeeze the excess onto the paper towel.
The samples were dried in a forced air oven @ 100° C. for 30 minutes.
They were then UV cured on one side, turned over, and cured on the other side.
The coated samples were weighed to get ″w2″.

Five-Layer Composite Molded for 40 Minutes @ 320° F.
Molded with EPDM Compound 67-N
(No Coagent)

| Test # | 70-AN | 70-BN | 70-CN | 70-DN | 70-EN | 70-FN |
|---|---|---|---|---|---|---|
| Formulation # | A | B | C | D | E | F |
| Fabric # | A1 | B1 | C1 | D1 | E | F |
| | | | | | (half of) | (half of) |
| Peak, pli | 28.5 | 23.3 | 24.7 | 14.9 | 8.7 | 13 |
| Mean, pli | 25.1 | 19.2 | 21.5 | 12.2 | 7.2 | 11.4 |
| % Cohesive | 20 | 0 | 0 | 0 | 0 | 0 |

Molded with EPDM Compound 67-A
(9.3 phr SR EPM 75 2-A)

| Test # | 71-AA | 71-BA | 71-CA | 71-DA | 71-EA | 71-FA |
|---|---|---|---|---|---|---|
| Formulation# | A | B | C | D | E | F |
| Fabric # | A2 | B2 | C2 | D2 | E | F |
| | | | | | (half of) | (half of) |
| Peak, pli | 46.8 | 46.9 | 45.3 | 43.2 | 30 | 27.9 |
| Mean, pli | 37.4 | 42.4 | 39 | 36.1 | 26.9 | 23.6 |
| % Cohesive | 100 | 100 | 100 | 60 | 10 | 0 |

SUMMARY:

| | T-Peel Adhesion with Peroxide Cured EPDM | | | |
|---|---|---|---|---|
| | | | 67-A | |
| | 67-N (no coagent) | | (9.3 hr SR EPM 75-2A) | |
| Dip Adhesive on Fabric | lbs./inch | % Cohesive | lbs./inch | % Cohesive |
| None | 4 | 0 | 26 | 20 |
| RFL | 24 | 10 | 33 | 100 |
| Ditrimethylolpropane Triacrylate | 25.1 | 20 | 37.4 | 100 |
| Ethoxylated Pentaerythritol | 19.2 | 0 | 42.4 | 100 |
| Tetraacrylate | | | | |
| Tris (2-Hydroxy Ethyl) Isocyanurate | | | | |
| Triacrylate | 21.5 | 0 | 39 | 100 |

EPDM compounds. A masterbatch, WE 5012, was made up containing:

| Ingredients | phr |
|---|---|
| Nordel IP 4640 | 100 |
| Carbon Black N 660 | 100 |
| Sunpar 2280 | 50 |
| Zinc Oxide | 5 |
| Stearic Acid | 1 |
| Total | 256 |

| Compound # | 67-N | 67-A |
|---|---|---|
| Masterbatch | 256 | 256 |
| WE 5012 | | |
| Naugard Q | 1.0 | 1.0 |
| DiCup 40 KE | 7.5 | 7.5 |
| SR EPM 75-2A | 0 | 9.3 |
| Totals | 264.5 | 273.8 |

What is claimed is:

1. A method of adhering rubber to fabric comprising applying an adhesive composition comprising an α, β-ethylenically unsaturated monomer and/or oligomer to a surface of the fabric, heating and/or irradiating the fabric, joining the rubber and adhesive surface of the fabric, and heating and pressing to vulcanize the rubber and bond the fabric to the rubber.

2. The method of claim 1 wherein the adhesive is partially cured by the heat and/or radiation prior to joining the rubber and adhesive surface of the fabric.

3. The method of claim 1 wherein the radiation is applied by ultraviolet light (UV) or electron beam.

4. The method of claim 1 wherein the composition includes a photoinitiator.

5. The method of claim 1 wherein the composition includes a thermal initiator.

6. The method of claim 1 wherein the fabric is heated for about 30 to 300 seconds at 75 to 250 deg. C.

7. The method of claim 1 wherein the fabric is heated and/or irradiated in the presence of air so as to at least partially cure the adhesive.

8. The method of claim 1 wherein the fabric has a solubility parameter and the monomer and/or oligomer is selected to have a solubility parameter near that of the fabric.

9. The method of claim 1 wherein the monomer and/or oligomer and the fabric are selected so that their solubility parameters are within one Hildebrand unit of each other.

10. The method of claim 1 wherein the solubility parameters of the fabric and the monomer and/or oligomer composition are between 8 and 17 Hildebrand units.

11. The method of claim 1 wherein the radiation is ultraviolet light (UV).

12. The method of claim 1 wherein the monomer and/or oligomer is selected from the group consisting of acids, esters, metallic salts, and amides.

13. The method of claim 1 wherein the monomer and/or oligomer is selected from the group consisting of di-, tri-, or tetra-acrylates or methacrylates.

14. The method of claim 1 wherein the monomer and/or oligomer is selected from the group consisting of ditrimethylolpropane triacrylate, ethoxylated pentaerythritol tetraacrylate, and tris (2-hydroxy ethyl)isocyanurate triacrylate.

15. The method of claim 1 wherein the adhesive comprises an initiator selected from the group consisting of photoinitiators and thermal initiators.

16. The method of claim 1 wherein the adhesive does not comprise an initiator, and the adhesive is cured by electron beam radiation.

17. A composite comprising rubber adhered to fabric by the method of claim 1.

18. The composite of claim 17 wherein the fabric is selected from the group consisting of cotton, rayon, nylon, polyester, and aramid.

19. The composite of claim 17 wherein the rubber is natural or synthetic.

20. The composite of claim 17 wherein the rubber is EPDM, the fabric is polyester, and the composition comprises a monomer selected from the group consisting of ditrimethylolpropane triacrylate, ethoxylated pentaerythritol tetraacrylate, and tris (2-hydroxy ethyl)isocyanurate triacrylate.
